(19) United States
(12) Patent Application Publication
(10) Pub. No.: US 2013/0185107 A1
(43) Pub. Date: Jul. 18, 2013

(54) SYSTEMS, METHODS AND COMPUTER READABLE MEDIA FOR MATCHING INDIVIDUALS WITH ORGANIZATIONAL JOBS/ROLES

(71) Applicants: Jennifer Asbury, Lakeland, FL (US); Thomas F. Asbury, Lakeland, FL (US)

(72) Inventors: Jennifer Asbury, Lakeland, FL (US); Thomas F. Asbury, Lakeland, FL (US)

(21) Appl. No.: 13/741,343

(22) Filed: Jan. 14, 2013

Related U.S. Application Data
(60) Provisional application No. 61/586,725, filed on Jan. 13, 2012.

(51) Int. Cl. G06Q 10/06

(52) U.S. Cl. CPC G06Q 10/063112
USPC 705/7.14

(57) ABSTRACT

Systems, methods and computer readable media for matching individuals with jobs/roles include using profiles of the individual and profiles of the job/roles.

Embodiments relate generally to matching individuals to roles in an organization and, more particularly, to systems, methods and computer readable media for matching individuals with organizational jobs/roles based on a profile of an individual and a profile of a job/role.

Conventionally, individuals (e.g., job candidates, either internal or external) may be matched with jobs and/or roles in an organization based on externally recognizable factors such as education level, training, professional licensing or credentials, previous work experience and/or the like. Conventional approaches may not take full account of less readily assessed or observed characteristics such as personality traits, mental agility, physical dexterity, creativeness, problem solving skills and/or the like.

Embodiments of the present invention have been conceived in light of the above mentioned problems or limitations, among other things.

### BRIEF DESCRIPTION OF THE DRAWINGS

FIG. 1 is a diagram of an exemplary system for matching individuals with roles in accordance with at least one embodiment.

FIG. 2 is a chart showing an exemplary process for matching individuals with roles in accordance with at least one embodiment.

FIG. 3 is a diagram of an exemplary system for individual profiling in accordance with at least one embodiment.

FIG. 4 is a diagram of an exemplary system for job/role profiling in accordance with at least one embodiment.

### DETAILED DESCRIPTION

While some embodiments are described herein in relation to jobs and job candidates, it will be appreciated that embodiments of the disclosed systems, methods and computer readable media can be used for any purpose where matching of an individual to a role is desired. Further, examples are described below in relation to personality profiling based on personality traits. However, it will be appreciated that other characteristics or features of an individual may be used in addition to or as an alternative to personality traits, such as mental agility, physical dexterity, creativeness, problem solving skills and/or the like.

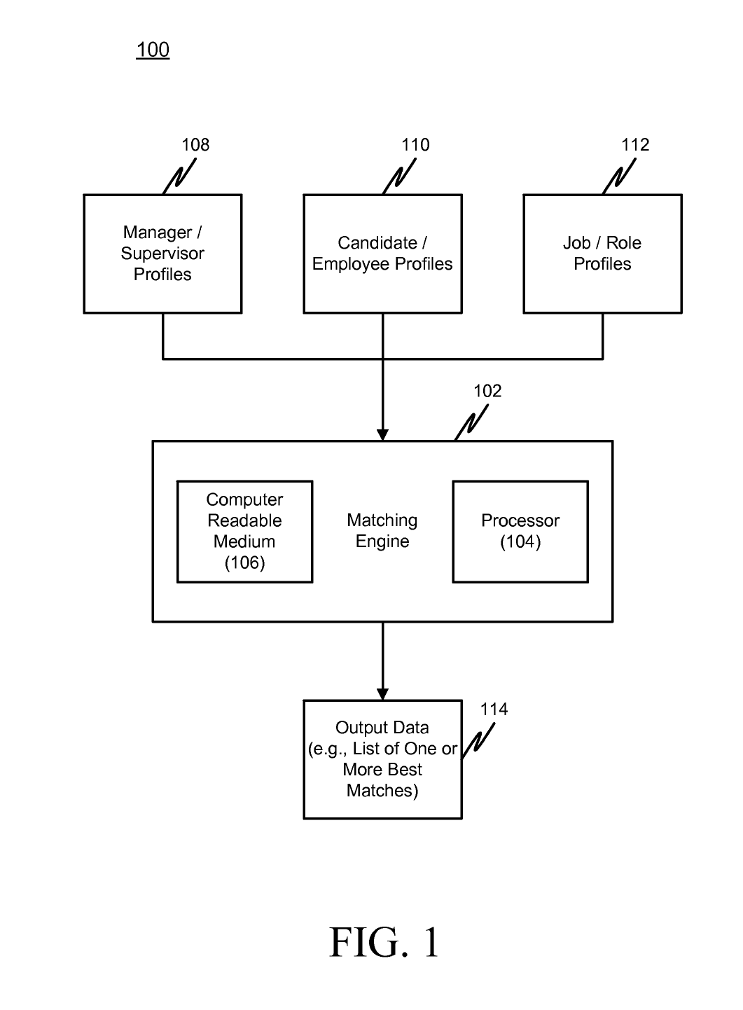

FIG. 1 is a diagram of an exemplary system 100 for matching individuals with jobs/roles. In particular, the system 100 includes a matching engine 102 (e.g., a computer system) having a processor 104 and a computer readable medium 106.

In operation, the matching engine 102 receives manager/supervisor profiles 108, candidate/employee profiles 110 and job/role profiles 112.

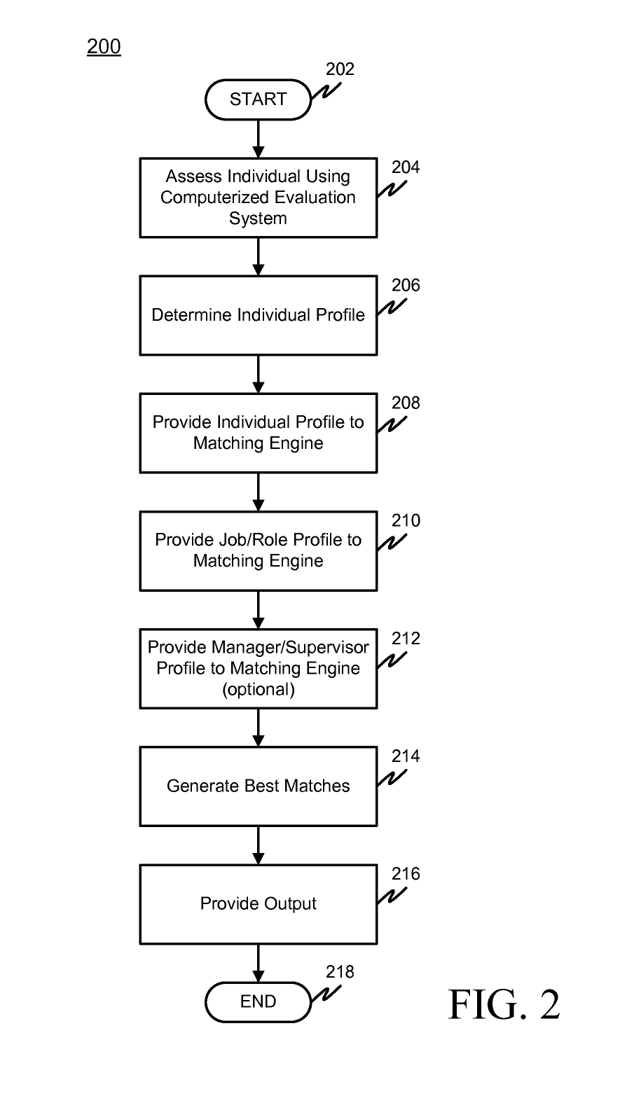

These profiles are processed to generate output data 114. The processing of data is described below in greater detail in reference to FIG. 2. The output data can include a list of one or more best matches between a particular job/role and the pool of candidates/employees. Thus, a job or role can be matched with an individual (either internal or external to the organization) that is best suited to the job or role based on a comparison of the job or role profile and the individual profiles.

The profiles can include one or more of the characteristics mentioned above and can be weighted to emphasize (or de-emphasize) certain characteristics by applying a numeric weighting factor to a particular characteristic.

FIG. 2 is a chart showing an exemplary process for matching individuals with roles. Processing beings at 202 and continues to 204.

At 204, an individual is assessed using a computerized evaluation system and the data from the assessment is stored. Processing continues to 206.

At 206, the stored assessment data is processed to obtain individual profile data corresponding to the particular characteristic or group of characteristics being assessed. Processing continues to 208.

At 208, the individual profile data is supplied to the matching engine. For example, the individual profile data may be stored in a database that is accessible by the matching engine. Processing continues to 210.

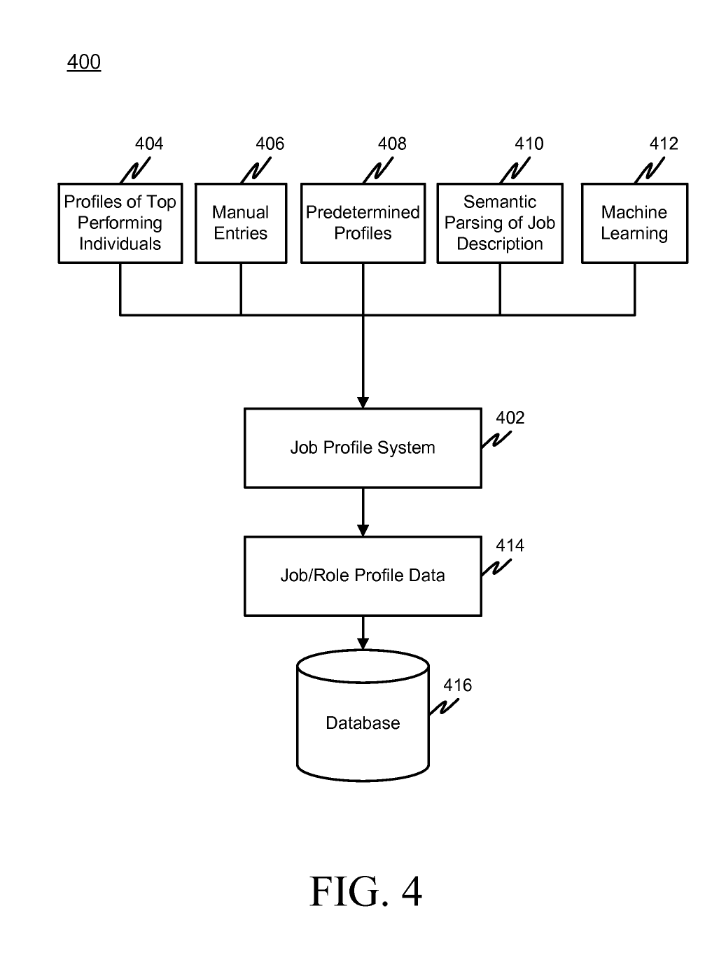

At 210, job/role profile data is provided to the matching engine. The job/role profile data can be provided by storing the job/role profile data in a database accessible to the matching engine. The process of generating job/role profile data is described in greater detail below in reference to FIG. 4. Processing continues to 212.

At 212, manager and/or supervisor data is optionally provided to the matching engine. For example, the manager and/or supervisor data may be stored in a database accessible to the matching engine and may be associated with corresponding jobs/role for which a respective manager/supervisor is responsible for managing. Processing continues to 214.

At 214, one or more best matches are generated. The one or more best matches can include, for example, one or more individuals best suited to particular job/role based on the profiles of the individuals and the profile of the job/role. Processing continues to 216.

At 216, an output of the best match results can be provided. The results can be displayed on a display device, sent to a printing device or transmitted to an external system via a wired or wireless network. Processing continues to 218, where processing ends.

It will be appreciated that 204-216 may be repeated in whole or in part in order to accomplish a contemplated matching task.

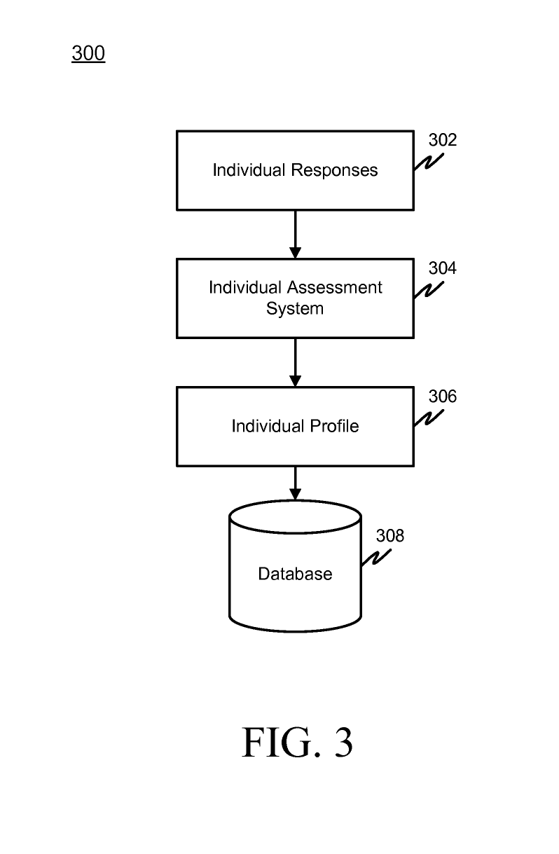

FIG. 3 is a diagram of an exemplary individual assessment system 300. Individual responses 302 to an assessment (e.g., a computerized assessment) are provided to an individual assessment system 304. The individual assessment system can process the responses in order to generate an individual profile 306.

The individual profile 306 can be stored in a database 308 that is accessible to the matching engine.

An important feature of an embodiment is that in addition to profiling individuals, jobs and/or roles are profiled as well, and the profiles of the jobs and/or roles are used to determine best matches between individuals and jobs/roles.

FIG. 4 is a diagram of an exemplary job/role assessment system 400.

Profile information about a job/role can be inputted from a variety of sources including profiles of top performers 404, manual entries 406, predetermined profiles 408, computerized semantic parsing of a job description 410 and machine learning 412.

The profiles of top performers 404 can include data derived from profiles of individuals in a particular role or job. By developing a statistical composite profile of top performers, the system can match candidates for a particular job/role with profile of the top performers to determine how closely a candidate matches the composite profile of the top performers.

The manual entries 406 can include entries made directly by a person familiar with the type of profiling being used. For example, in a personality trait-type profiling system a trained person familiar with the DISC methodology can develop a profile of a job/role based on the trained person's knowledge of the personality traits as defined within a particular profiling methodology. It will be appreciated that other personality profiling methodologies could be used.

The predetermined profiles 408 could include profiles created beforehand by a person familiar with the type of profiling being used and based on the type of job/role. For example, for an outside sales role, a particular personality profile may be desired. This profile could be created and associated with the job of outside sales, such that when an outside sales position becomes open, the matching engine could match available candidates against the predetermined profile associated with outside sales.

The semantic parsing of job descriptions 410 is an automatic process in which a machine processes a job description to extract information relevant to building a profile for that job. For example, the machine could search for specific words or phrases or perform more advanced semantic or other processing on a text job description.

The machine learning 412 could include providing a feedback loop (via computer hardware and/or software) that would allow a machine learning program to gather feedback on how well individuals were doing in various roles and attempt to assign a profile to the roles based on machine learning algorithms. These profiles could be adjusted as the machine learns and collects data.

The job profile system 402 takes in job profile information from one or more of the various sources (404-412) and creates job/role profile data 414 that can be stored in a database 416 for access by a matching engine.

It will be appreciated that the modules, processes, systems, and sections described above can be implemented in hardware, hardware programmed by software, software instructions stored on a nontransitory computer readable medium or a combination of the above. A system for matching individuals with jobs/roles, for example, can include using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium (e.g., 106 of FIG. 1) such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and/or image processing arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and computer readable media for matching individuals with jobs/roles.

While the invention has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the invention.

What is claimed is:

1. A system for matching an individual with a role, the system comprising:
any feature described, either individually or in combination with any feature, in any configuration.

2. A method of matching an individual to a role, the method comprising:
one or more steps of any process described, in any order, using any modality described.

3. A nontransitory computer readable medium having stored thereon software instructions that, when executed by a processor, cause the processor to perform a series of steps comprising:
one or more steps of any process described, in any order, using any modality described.
